(19) United States
(12) Patent Application Publication
(10) Pub. No.: US 2026/0011158 A1
(43) Pub. Date: Jan. 8, 2026

(54) Device and Method for Training a Lane Detector

(71) Applicant: Robert Bosch GmbH, Stuttgart (DE)

(72) Inventors: Houssem Boulahbal, Leonberg (DE); Thomas Michalke, Weil Der Stadt (DE)

(21) Appl. No.: 19/257,958

(22) Filed: Jul. 2, 2025

(30) Foreign Application Priority Data
Jul. 3, 2024 (DE) 10 2024 206 262.6

(51) Int. Cl. G06V 20/56; B60W 30/12; B60W 60/00; G06V 10/82

(52) U.S. Cl. CPC G06V 20/588; B60W 30/12; B60W 60/0015; G06V 10/82; B60W 2420/403; B60W 2552/53

(57) ABSTRACT

A computer-implemented method is disclosed for training a lane detector for detecting a lane in a digital image, in particular based on pixel values of the digital image. The method includes (i) providing a first plurality of digital images with marked lanes labeled with lane markings, (ii) obtaining a second plurality of digital images from the first plurality of digital images by removing the lane markings from the digital images of the first plurality of digital images, thereby generating corresponding digital images without markings, (iii) providing data for characterizing the lanes in the digital images of the first plurality of digital images, and (iv) providing a data set for training the lane detector. The data set includes pairs of a digital image and data characterizing a fundamental truth of a lane in the digital image. The digital image is taken from the second plurality of digital images, and the data characterizes the lane identified in the corresponding digital image from the first plurality of digital images.

This application claims priority under 35 U.S.C. § 119 to application no. DE 10 2024 206 262.6, filed on Jul. 3, 2024 in Germany, the disclosure of which is incorporated herein by reference in its entirety.

The disclosure relates to a computer-implemented method for training a lane detector, a method for operating an at least partially automated vehicle, a data set, computer readable storage media, and computer programs.

### BACKGROUND

DE 10 2010 062 129 B4 discloses a method for lane recognition based on lane markings of the lane.

The method with the features set forth below has the advantage that the derived lane detector can operate reliably even if there are no lane markings.

Further improvements are described below as well. Further aspects of the disclosure are also described below.

### SUMMARY

In a first aspect, the disclosure relates to a computer-implemented method for training a lane detector to detect a lane in a digital image, in particular based on pixel values of the digital image. This method includes providing a first plurality of digital images with marked lanes, obtaining a second plurality of digital images by removing the lane markings, providing data for characterizing lanes in the first plurality of digital images, and providing a data set comprising pairs of a digital image from the second plurality and data characterizing a fundamental truth of a lane in the corresponding digital image from the first plurality. This method enables the creation of a high-quality training data set for lane detectors that can accurately detect lanes on unmarked roads using images with artificially removed lane markings, thereby improving the detector's ability to generalize from marked to unmarked road conditions without the need for expensive HD maps or manual labeling.

“Without markings” can mean that the lane markings on the road ahead are removed; it does not necessarily imply that all lane markings anywhere in the image are removed, nor does it imply that all markings are removed. “Data for characterizing lanes” may be a semantic segmentation of the image in which the pixels corresponding to the lane are marked as such. Similarly, the “fundamental truth of a lane” may also be a semantic segmentation of the image in which the pixels corresponding to the lane are marked as such.

In other words, the lane is identified from the image with the lane marking, the lane marking is removed from the image, and the identified lane is then used as a fundamental truth to train the lane detector in a supervised manner to identify the lane without the lane marking.

In a second aspect, the disclosure deals with the step of providing data for characterizing lanes in the digital images of the first plurality of digital images by identifying the lanes in these digital images with a lane marking detector. This approach automates the labeling process of lane markings in the data set, wherein the time and effort required for manual labeling is significantly reduced, and ensures high accuracy in the fundamental truth data by using reliable algorithms for lane marking detection.

The method further comprises identifying lanes in the digital images of the first plurality using a lane marking detector by identifying lane markings in the digital images and identifying lanes based on the identified lane markings. This step refines the process of generating fundamental truth data for the training data set by ensuring that the identification of lanes depends directly on the accurate detection of lane markings, thereby improving the reliability and accuracy of the training process for lane recognition.

The step of removing the lane markings can be performed using a generative model, in particular a stable diffusion model, or a Generative Adversarial Network (GAN), or a Variational Autoencoder (VAE) by removing the lane markings with a texture that approximately matches the texture of a region near the lane marking in the image from which the lane marking is to be removed. Using a generative model, in particular a stable diffusion model, to remove lane markings and replace them with a texture that matches the surrounding road surface allows the generation of very realistic images without markings. This improves the ability of the lane detector to work accurately in real-world conditions where lane markings may be faded or missing.

The method further comprises training the lane detector using the provided data set. Training the lane detector using a data set that includes images with distant lane markings and corresponding fundamental truth data significantly improves the detector's performance in recognizing lanes on unmarked roads, resulting in more reliable and safer automated driving systems.

The training comprises obtaining data for characterizing a lane in a provided digital image from the data set with the lane detector, and adjusting parameters that characterize the behavior of the lane detector depending on the obtained data for characterizing the lane and the corresponding coupled data for characterizing the fundamental truth of the lane from the set data set. In this iterative training process, which involves adjusting the parameters of the lane detector based on a comparison between its output and the fundamental truth data, the detector's algorithms are refined for improved accuracy and reliability in lane recognition, especially in difficult road conditions without markings.

A method for operating an at least partially automated vehicle, in which the lane detector is first trained in accordance with the method described, and then providing images characterizing the surroundings of the vehicle, for inputting the provided image into the lane detector to obtain data characterizing the lane in the provided image, and for operating the vehicle depending on the detected lane characterized by the captured data. This method enables the practical application of the trained lane detector in at least partially automated vehicles, thereby enabling accurate lane recognition in real time, which is crucial for safe navigation and safe operation of the vehicle in surroundings with unmarked roads, thereby improving the safety and reliability of systems for automated driving.

### BRIEF DESCRIPTION OF THE DRAWINGS

Description of embodiments The embodiments of the disclosure are discussed in more detail with reference to the following figures. The figures show the following:

FIG. 1 a diagram illustrating an interaction between the lane detector and an actuator;

FIG. 2 a at least partially automated vehicle comprising a lane detector;

FIG. 3 a training system for training the lane detector;

FIG. 4 in a flowchart a method for generating a labeled video data set;

FIG. 5 in a flowchart shows a method for training a lane detector with this data set;

FIG. 6 in a flowchart a method for operating a vehicle with this lane detector;

FIG. 7 an illustration of images with and without lane markings.

### DETAILED DESCRIPTION

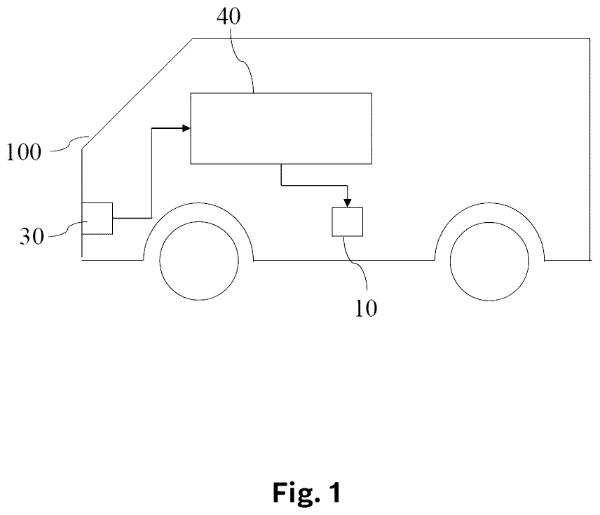

FIG. 1 shows an embodiment of actuator 10 in its surroundings 20. The actuator 10 interacts with control system 40. The actuator 10 and its surroundings 20 are collectively referred to as the actuator system. With preferably equal intervals, sensor 30, which preferably comprises an optical sensor, is configured to take pictures of the surroundings 20. An output signal S of the sensor 30 (or, if the sensor 30 comprises a plurality of sensors, an output signal S for each of the sensors) encoding the images is transmitted to the control system 40.

The control system 40 receives a stream of video signals S. It then calculates a series of actuator control commands A depending on the stream of video signals S, which are then transmitted to the actuator 10.

The control system 40 receives the stream of video signals S from the sensor 30 in an optional receiving unit 50. The receiving unit 50 converts the sensor signals S into input signals x. Alternatively, if there is no receiving unit 50, each video signal S can be used directly as an input signal x. The input signal x can, for example, be specified as an extract from the video signal S. Alternatively, the video signal S can be processed to obtain the input signal x. The input signal x comprises image data corresponding to an image recorded by the sensor 30. In other words, the input signal x is provided in accordance with the video signal S.

The input signal x is then forwarded to lane detector 60, which may be provided by an artificial neural network, for example.

The classifier 60 is parameterized by parameters @ that are stored in and provided by parameter storageSt₁.

The lane detector 60 determines output signals y from the input signals x. The output signal y contains information that characterizes a lane in the input signal x. Output signals y are transmitted to planning unit 80, which converts the output signals y into the control commands A. The actuator control commands A are then transmitted to the actuator 10 to control the actuator 10 accordingly. Alternatively, output signals y can be used directly as control commands A.

The actuator 10 receives actuator control commands A, is controlled accordingly and executes an action that corresponds to the actuator control commands A. The actuator 10 can comprise control logic that converts the actuator control command A into another control command, which is then used to control the actuator 10.

In further embodiments, the control system 40 may comprise the sensor 30. In even further embodiments, the control system 40 may alternatively or additionally comprise the actuator 10.

In addition, the control system 40 may comprise processor 45 (or a plurality of processors) and at least one machine-readable storage medium 46 on which instructions are stored that, when executed, cause the control system 40 to perform a method according to an aspect of the disclosure.

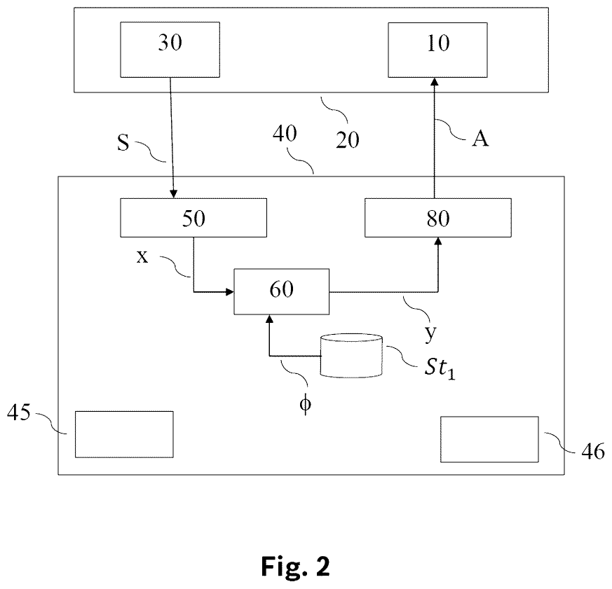

FIG. 2 shows an embodiment in which a control system 40 is used to control an at least partially autonomous vehicle 100.

The sensor 30 comprises one or more video sensors. Some or all of these sensors are preferably, but not necessarily, integrated into the vehicle 100.

For example, by using the input signal x, the lane detector 60 may, for example, detect a lane in front of the at least partially autonomous vehicle 100. The output signal y can comprise information that characterizes where the lane is located. The control command A can then be determined according to this information, for example to steer along this lane.

The actuator 10, which is preferably integrated into the vehicle 100, can be provided by a brake, a drive system, an engine, a drive train or a steering system of the vehicle 100. The actuator control commands A can be determined such that the actuator (or actuators) 10 is/are controlled such that the vehicle 100 avoids collisions with the detected objects.

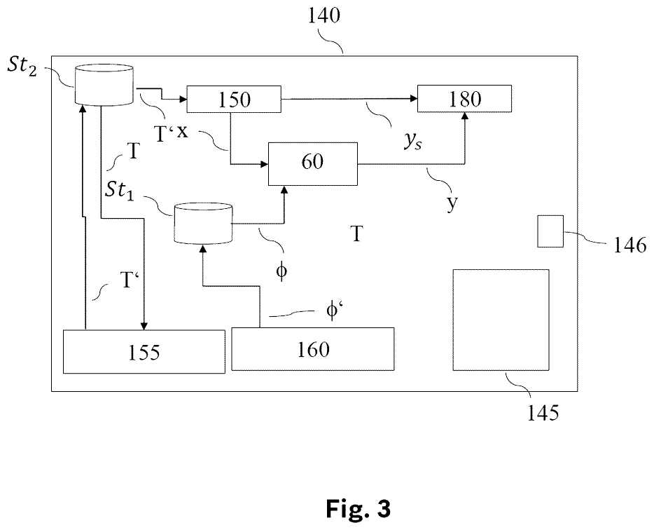

In FIG. 3, an embodiment of training system 140 for training lane detector 60 is shown. Training data unit 150 determines input signals x, i.e. images, which are forwarded to lane detector 60. For example, the training data unit 150 may access a computer-implemented database St₂ in which a set T′ of training data is stored. The set T′ comprises pairs of images x without markings and corresponding information about the desired lane segmentation yₛ. The training data unit 150 selects samples from the set T′, for example at random. The input signal x of a selected sample is forwarded to the lane detector 60. The desired output signal yₛ is forwarded to evaluation unit 180.

Data set extension unit 155 is used to calculate a data set T′ without markings, which includes modified images x, which were taken, for example, from the training set T, and their respective desired lane segmentation information yₛ (derived from images of the training set T using a standard lane recognition algorithm that identifies lane markings and then identifies lanes based on the lane markings) using the method illustrated in FIG. 1.

The lane detector 60 is configured to calculate output signals y from input signals x. These output signals y are also forwarded to the evaluation unit 180.

Modification unit 160 determines updated parameters ϕ′ depending on the input from the evaluation unit 180. Updated parameters ϕ′ are transferred to the parameter storage St₁ to replace the current parameters ϕ.

For example, it can be provided that the evaluation unit 180 determines the value of a loss function L depending on the output signals y and the desired output signals yₛ. The modification unit 160 can then calculate updated parameters ¢′, for example by using the stochastic gradient descent to optimize the loss function [symbol] .

In addition, the training system 140 may comprise a processor 145 (or a plurality of processors) and at least one machine-readable storage medium 146 on which instructions are stored which, when executed, cause the control system 140 to perform a method according to an aspect of the disclosure.

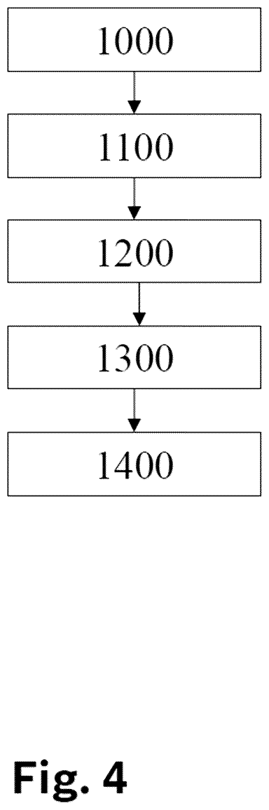

FIG. 4 shows a flowchart that discloses an embodiment of a method for automatically generating a wide-area labeled video data set T′ for training lane detector 60 operating on roads without lane markings.

First (1000), an extensive data set (T) is received, consisting of digital images with marked lanes from a user or a database.

Then (1100), an algorithm for detecting lane markings on images of the received data set (T) is executed to identify and document lane markings (yₛ) in each image.

Then (1200), a generative AI model, in particular stable diffusion models, is applied to remove the identified lane markings rom the images. The models replace the removed lane markings with textures that approximate the surrounding lane surface, creating road images without markings.

Then (1300) each image is processed by the generative model to remove lane markings and transform the entire data set. The converted images are stored together with the original lane markings, which serve as fundamental truth data for the corresponding images without markings.

Next (1,400), a data set T′ is provided, comprising pairs of digital images x without markings and corresponding fundamental truth data characterizing the lanes captured in the original images x.yₛ This completes this part of the method.

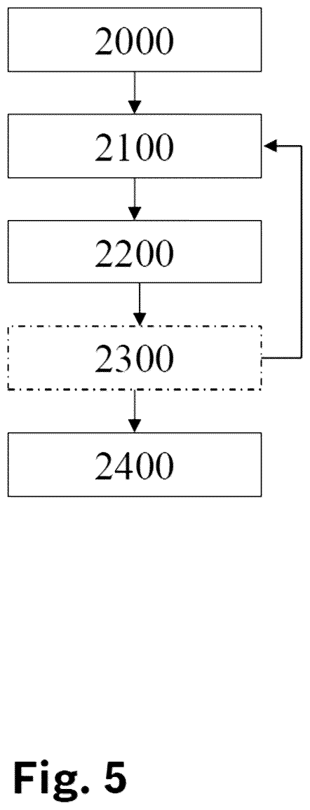

FIG. 5 shows a flowchart disclosing an embodiment of a method for training the lane detector 60, which is suitable for identifying lanes in digital images, in particular those without explicit lane markings.

First (2000), the generated data set T′ obtained by the method illustrated in FIG. 1, which includes pairs of images x without markings and fundamental truth data yₛ for lanes, is provided.

Then (2100), a machine learning model 60 is provided for the lane recognition task.

Then (2200), the images x are input into the machine learning model 60 without any markings. The lane recognition output y of the model is compared with the fundamental truth data yₛ for each image x, and the parameters ϕ of the model are adjusted based on the comparison to minimize a cost function that includes a term that penalizes deviations between the detected lanes y and the yₛ fundamental truth.

Then (2300) the performance of the trained model is optionally evaluated on a separate validation set. If necessary, the training process is repeated with adjusted parameters or model architecture to improve accuracy and reliability.

Then (2400) the lane detector 60 is provided, which is trained to detect lanes in digital images without explicit lane markings and is therefore optimized for high accuracy and reliability. This completes this part of the method.

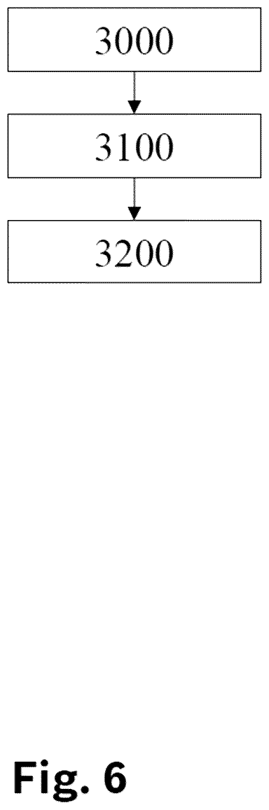

FIG. 6 shows a flowchart of a method that discloses using the trained lane detector 60 in the at least partially automated vehicle 100 for real-time lane recognition and vehicle guidance.

First (3000), the vehicle 100 is provided with the trained lane detector 60 integrated into the vehicle's on-board control system 40.

Then (3100), this control system 40 continuously receives images S characterizing the vehicle environment from the camera 30 mounted on the vehicle 100. These images S are then processed by the trained lane detector 60 to identify lanes in real time.

Then (3200), the vehicle 60 uses the data characterizing the detected lanes y to inform the vehicle's steering and navigation systems. The movement and speed of the vehicle are adjusted by the actuators (10) based on the detected lanes to maintain safe and accurate lane tracking. This completes this part of the method.

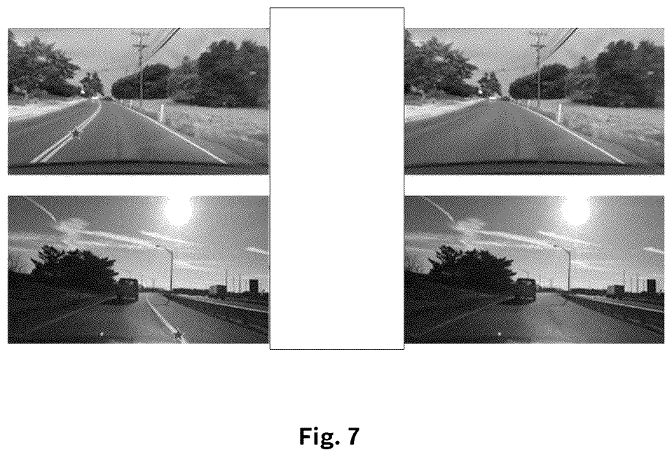

FIG. 7 illustrates examples of lanes with lane markings (left column) and corresponding images without markings with removed lane markings (right column). The lane markings that are to be removed are marked with an asterisk. It should be noted that the other lane markings on the opposite side of the lane may be retained as shown in this figure, i.e., it is not necessary to remove all lane markings.

What is claimed is:

1. A computer-implemented method for training a lane detector for detecting a lane in a digital image based on pixel values of the digital image, comprising:
providing a first plurality of digital images with marked lanes labeled with lane markings;
obtaining a second plurality of digital images from the first plurality of digital images by removing the lane markings from the digital images of the first plurality of digital images, thereby generating corresponding digital images without markings;
providing data for characterizing the lanes in the digital images of the first plurality of digital images; and
providing a data set for training the lane detector, wherein the data set comprises pairs of a digital image and data characterizing a fundamental truth of a lane in the digital image, and wherein the digital image is taken from the second plurality of digital images, and the data characterizes the lane identified in the corresponding digital image from the first plurality of digital images.

2. The method according to claim 1, wherein providing data for characterizing lanes in the digital images of the first plurality of digital images comprises identifying lanes in the digital images of the first plurality of digital images with a lane marking detector.

3. The method according to claim 2, wherein identifying lanes in the digital images of the first plurality of digital images with the lane marking detector comprises identifying lane markings in the digital images and identifying lanes depending on the identified lane markings.

4. The method according to claim 1, wherein removing the lane markings is carried out using a generative model by removing the lane markings with a texture that approximately corresponds to the texture of a region in the vicinity of the lane marking in the image from which the lane marking is to be removed.

5. The method according to claim 1, further comprising training the lane detector with the data set.

6. The method according to claim 5, wherein the training comprises obtaining data for characterizing a lane in a provided digital image from the data set with the lane detector, and adjusting parameters that characterize the behavior of the lane detector depending on the obtained data for characterizing the lane and the corresponding coupled data that characterize the fundamental truth of the lane from the adjusted data set.

7. A method for operating an at least partially automated vehicle, comprising:
training the lane detector according to the method of claim 5;
providing images which characterize the surroundings of the vehicle;
inputting the provided image into the lane detector to obtain data characterizing the lane in the provided image, and
operating the vehicle depending on the detected lane characterized by the obtained data.

8. A data set provided in the method according to claim 1.

9. A computer-readable storage medium in which the data set according to claim 8 is stored.

10. A computer program configured to perform the method according to claim 1.

11. A computer-readable storage medium in which the computer program according to claim 10 is stored.

12. A computer configured to perform the method according to claim 1.

13. A lane detector trained by the method according to claim 5.

14. The method according to claim 1, wherein removing the lane markings is carried out using a stable diffusion model by removing the lane markings with a texture that approximately corresponds to the texture of a region in the vicinity of the lane marking in the image from which the lane marking is to be removed.

15. The method according to claim 7, wherein the images are obtained by a camera mounted on the vehicle.
